(19) United States
(12) Patent Application Publication
(10) Pub. No.: US 2016/0314779 A1
(43) Pub. Date: Oct. 27, 2016

(54) CENTRAL NOISE REDUCTION LOUDSPEAKER

(71) Applicant: Jetvox Acoustic Corp., Taoyuan City (TW)

(72) Inventor: To-Teng HUANG, Taoyuan City (TW)

(21) Appl. No.: 14/815,161

(22) Filed: Jul. 31, 2015

(30) Foreign Application Priority Data
Apr. 24, 2015 (TW) 104206346

(51) Int. Cl. G10K 11/178; H04R 9/04; H04R 9/06

(52) U.S. Cl. CPC G10K 11/1788; H04R 9/06; H04R 9/045; G10K 2210/12; G10K 2210/3229; G10K 2210/3226

(57) ABSTRACT

A central noise reduction loudspeaker includes a speaker unit, a top cap, a seat body, and a microphone. The speaker unit includes a diaphragm, and the diaphragm includes a central through hole located at center of the diaphragm. The top cap covers the seat body, and the speaker unit is disposed between the top cap and the seat body. The top cap includes a central fixed frame penetrating the central through hole of the diaphragm. The microphone is disposed within the central fixed frame and located in the central through hole. Since the microphone is disposed in central through hole, compared to conventional, the front cavity and the overall size of the loudspeaker or earphone can be reduced and the production process can be simplified.

### CROSS-REFERENCES TO RELATED APPLICATIONS

This non-provisional application claims priority under 35 U.S.C. §119(a) on Patent Application No. 104206346 filed in Taiwan, R.O.C. on Apr. 24, 2015, the entire contents of which are hereby incorporated by reference.

### BACKGROUND

1. Technical Field

The instant disclosure relates to the field of loudspeaker, in particular, to a noise reduction loudspeaker with centrally-configured microphone.

2. Related Art

Business person or commuters who love music usually listen to music during taking public transportation or being in a crowded environment. However, the hearing quality is reduced by the interference between the music from speaker and ambient noise. Accordingly, the listeners usually turn up the volume of the speaker to override the noise. This action damages the hearing ability of the listeners.

Therefore, there is a need to reduce the ambient noise. Traditionally, the common ways to reduce the ambient noise includes the passive way and the active way. The passive way is also known as the physics way. In the passive way, the bodies of earmuffs or earplugs are utilized to block the ambient noise out of the ear canal. The key of blocking out the ambient noise is the materials and shape (size) of the bodies of the earmuffs or earplugs. In order to block out the ambient noise, the body of the passive noise reduction earphone is thicker and heavier. However, thicker bodies of earmuffs or earplugs still cannot effectively block out the low-frequency noise like the noises from the engine or the power drill.

The active noise reduction is also known as the electronic type. The active noise reduction earphones reduce the ambient noise by disposing a microphone and a noise-cancelling circuitry. In general, the microphone is disposed near the ear canal to receives and magnify the ambient noise the signal of the ambient noise, and a inverter disposed on the inverting circuit emits a sound wave in phase-reversed form to cancel the original ambient noise that the wearer can hear through destructive interference. The effect of the active type of noise reduction is better than the passive type.

The active reduction loudspeaker or earphone utilizes a fixing element or a fixing seat to fix the microphone in the front cavity between the speaker unit and the bass unit. Accordingly, the space of the front cavity needs to be increased and the overall size of the loudspeaker or earphone is increased as well. In addition, the assembly process becomes complex, and the production cost increases.

### SUMMARY

To address the above issue, the instant disclosure provides a central noise reduction loudspeaker. According to one embodiment, the central noise reduction loudspeaker comprises a speaker unit, a seat body, a top cap, and a microphone. The speaker unit is disposed within the seat body. The top cap covers the seat body, and the speaker unit is between the top cap and the seat body. The top cap comprises a central fixed frame penetrating the central through hole of the diaphragm. The microphone is disposed within the central fixed frame and located in the central through hole.

In one embodiment, the seat body comprises an outer ring seat. The top cap comprises an outer ring frame. The outer ring frame is correspondingly assembled with the outer ring seat so that an outer periphery of the diaphragm is clamped between the outer ring frame and the outer ring seat.

In one embodiment, the seat body comprises an inner ring seat. The top cap comprises an inner ring frame. The inner ring frame is correspondingly disposed on the inner ring seat so that an inner periphery of the diaphragm is clamped between the inner ring frame and the inner ring seat.

In one embodiment, the speaker unit comprises an upper yoke, a magnet, and a lower yoke. The magnet is disposed between the upper yoke and the lower yoke. The lower yoke is disposed on the seat body and comprises a flange to fix the magnet. The diaphragm is connected to a voice coil, and the voice coil is located within a gap between the flange and the magnet.

In one embodiment, the speaker unit and the microphone are electrically connected with a circuit board, and the circuit board is disposed on the bottom of the seat body.

According to one embodiment of central noise reduction loudspeaker, the central noise reduction loudspeaker comprises a speaker unit, a support seat, and a microphone. The speaker unit comprises a diaphragm, the central of the diaphragm defines a central through hole. The support seat supports the speaker unit and comprises a central fixed frame. The central fixed frame penetrates the central through hole of the diaphragm. The microphone is disposed within the central fixed frame and located in the central through hole.

In one embodiment, the seat body comprises a seat body and a top cap, and the central fixed frame is disposed on the seat body. In other embodiment, the central fixed frame is disposed on the top cap.

Furthermore, the central noise reduction loudspeaker can be disposed within an ear housing to form a noise reduction earphone.

One of the features of the central noise reduction loudspeaker is that the diaphragm comprises the central through hole. With the central through hole, the diaphragm is capable of vibrating in a larger amplitude and higher frequency. Therefore, the audio signal can be performed closer to the original audio signal with less distortion. In addition, the microphone receives the ambient noise, and an inverter disposed on the inverting circuit emits a sound wave in phase-reversed form to cancel the ambient noise through destructive interference so as to increase the signal-to-noise ratio (SNR) and increase the audio resolution. Furthermore, since the microphone is disposed in central through hole, compared to conventional, the front cavity and the overall size of the loudspeaker or earphone can be reduced and the production process can be simplified.

### BRIEF DESCRIPTION OF THE DRAWINGS

FIG. 1 illustrates an exploded view of a central noise reduction loudspeaker according to the first embodiment of the instant disclosure.

FIG. 2 illustrates a cross-sectional view of a central noise reduction loudspeaker according to the first embodiment of the instant disclosure.

FIG. 3 illustrates a cross-sectional view of a central noise reduction loudspeaker according to the second embodiment of the instant disclosure.

FIG. 4 illustrates an exploded view of a central noise reduction loudspeaker assembly with an ear housing according to one embodiment.

FIG. 5 illustrates a cross-sectional view diagram of a central noise reduction loudspeaker assembled with an ear housing according to one embodiment.

### DETAILED DESCRIPTION

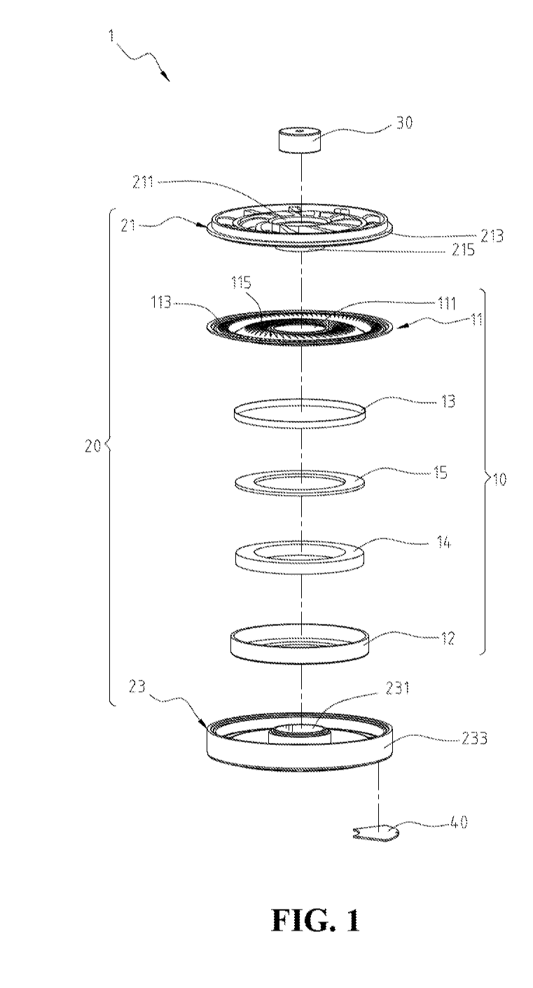

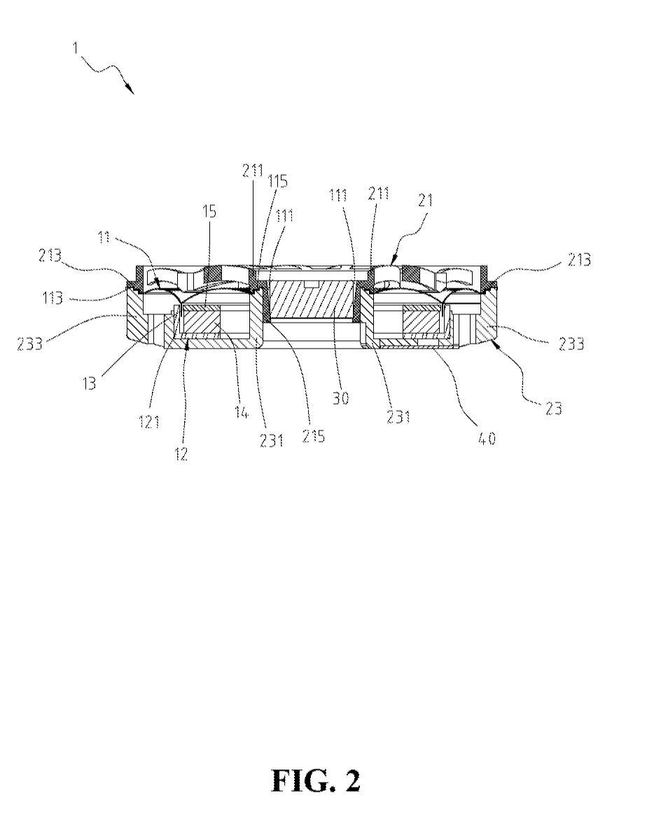

Please refer to FIGS. 1 and 2. FIGS. 1 and 2 respectively illustrate exploded view and cross-sectional view of a central noise reduction loudspeaker according to the first embodiment of the instant disclosure. As shown in FIGS. 1 and 2, in the first embodiment, the central noise reduction loudspeaker 1 comprises a speaker unit 10, a support seat 20, and a microphone 30. The speaker unit 10 can be a moving coil loudspeaker unit or a balanced armature loudspeaker unit. In this embodiment, that the speaker unit 10 is the balanced armature loudspeaker unit is provided for illustration. The speaker unit 10 comprises a diaphragm 11, and the diaphragm 11 comprises a central through hole 111 located at center of the diaphragm 11. The support seat 20 comprises a top cap 21 and a seat body 23. The top cap 21 covers the seat body 23, and the seat body 23 is disposed with the speaker unit 10. The speaker unit 10 is disposed between the top cap 21 and the seat body 23. The top cap 21 comprises a central fixed frame 215 penetrating the central through hole 111 of the diaphragm 11. The microphone 30 is disposed within the central fixed frame 215 and located in the central through hole 111.

As shown in FIGS. 1 and 2, the top cap 21 further comprises an inner ring frame 211 and an outer ring frame 213. The seat body 23 comprises an inner ring seat 231 and an outer ring seat 233. The inner ring frame 211 is correspondingly assembled with the inner ring seat 231. The central fixed frame 215 is closely near the inner ring seat 231. The outer ring frame 213 is correspondingly disposed on the outer ring seat 233. Furthermore, an outer periphery 115 of the diaphragm 11 is clamped between the outer ring frame 213 and the outer ring seat 233. An inner periphery 113 of the diaphragm 11 near the central through hole 111 is clamped between the inner ring frame 211 and the inner ring seat 231. The top cap 21 covers the surface of the diaphragm 11, and the central fixed frame 215 penetrates the central through hole 111 of the diaphragm 11. The central fixed frame 215 is a hollow column and the diameter of the central fixed frame 215 decreases gradually from top end toward bottom end so that the microphone 30 can engage the inner wall of the central fixed frame 215.

The speaker unit 10 and the microphone 30 are electrically connected with a circuit board 40. The circuit of the circuit board 40 has phase inverting circuit. The circuit board 40 provides an inverting circuit to emit a sound wave in phase-reversed form to cancel the ambient noise receive from the microphone 30 through destructive interference. The microphone 30 is an omnidirectional microphone for receiving the noise from whole chamber.

Furthermore, the speaker unit 10 comprises a lower yoke 12, a voice coil 13, a magnet 14, and an upper yoke 15. The voice coil 13 is connected with another surface of the diaphragm 11 which opposite to the surface that the top cap 21 is disposed on. The magnet 14 is disposed between the upper yoke 15 and the lower yoke 12. The lower yoke 12 is disposed on the seat body 23 and comprises a flange 121 to fix the magnet 14. The voice coil 13 is located within a gap between the flange 121 and the magnet 14. When the voice coil 13 is driven by an electric current and produces a magnetic field, the magnetic field of the voice coil 13 reacts with a permanent magnetic field produced by the magnet 14 so that the voice coil 13 can pushes the diaphragm 11.

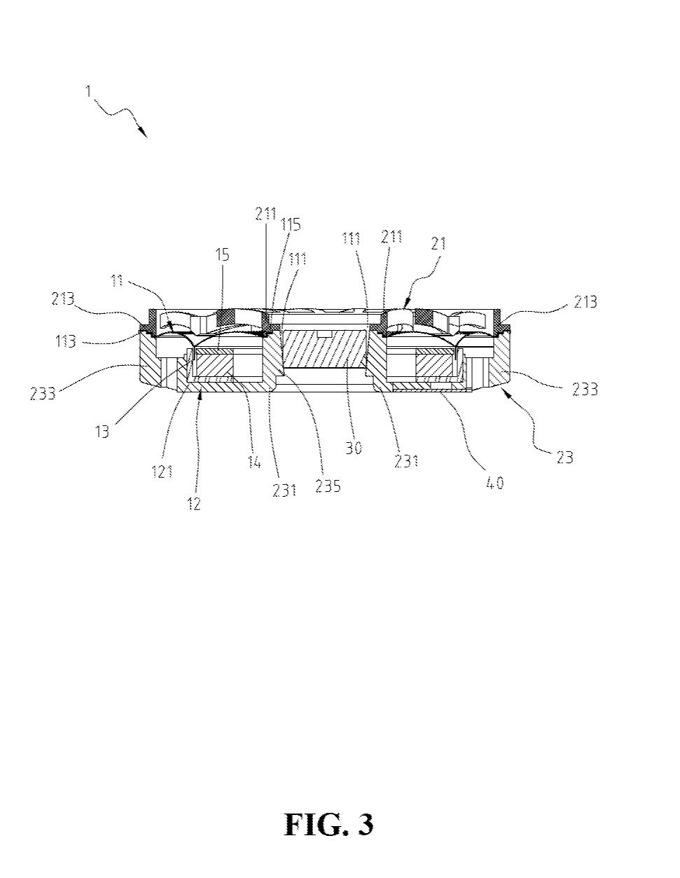

Please refer to FIG. 3. FIG. 3 illustrates a cross-sectional view of a central noise reduction loudspeaker according to the second embodiment of the instant disclosure. As shown in FIG. 3, in the second embodiment, the central noise reduction loudspeaker 1 comprises a speaker unit 10, a support seat 20, and a microphone 30. The detailed description of the structure of the speaker unit 10 and the microphone 30 refer to the foregoing description, and the common features are not described again.

In the second embodiment, the difference between the first embodiment and the second embodiment is mainly the support seat 20. The support seat 20 comprises a top cap 21 and a seat body 23. The top cap 21 covers the seat body 23, and the speaker unit 10 is disposed between the top cap 21 and the seat body 23. The seat body 23 comprises a central fixed frame 235. The central fixed frame 235 penetrates the central through hole 111 of the diaphragm 11. The microphone 30 engages in the central fixed frame 235. Beside, the central fixed frame 235 is a hollow column and the diameter of the central fixed frame 235 decreases gradually from top end toward bottom end so that the microphone 30 can engage the inner wall of the central fixed frame 235.

In practical structure, the structures of the top cap 21 and the seat body 23 and the engagement methods of the microphone 30 can change according to the practical demand. The foregoing description is merely provided for example and illustration, without any intention to be used for limiting the present disclosure.

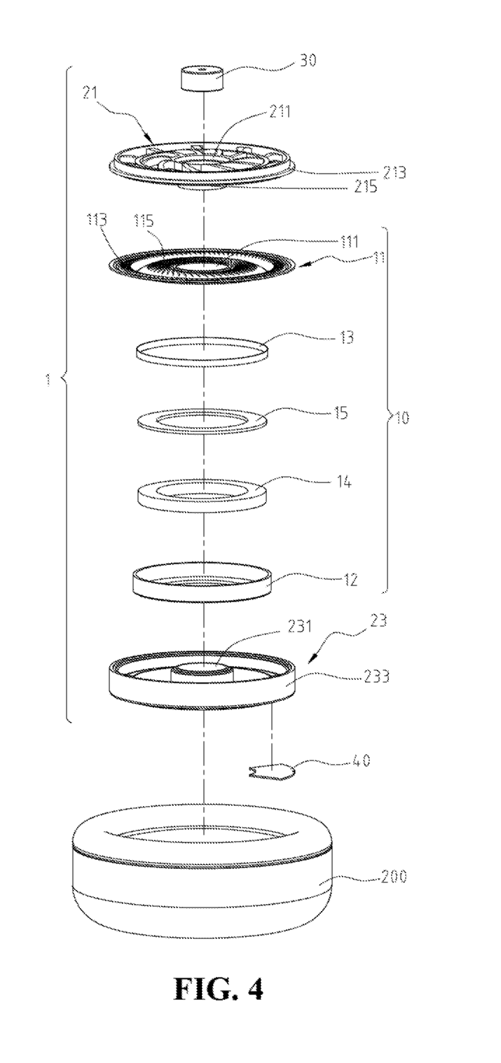

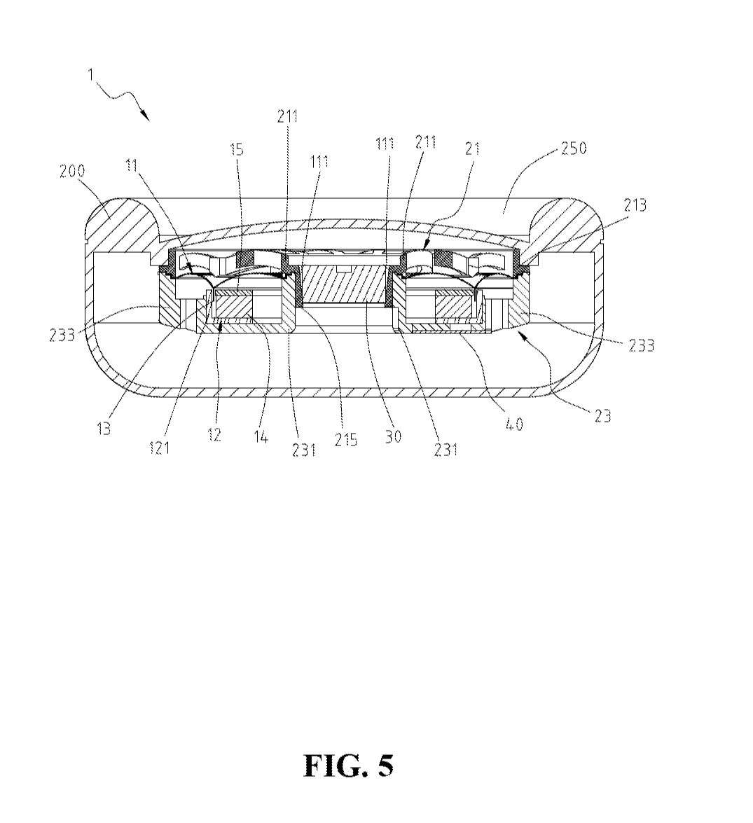

Please refer to FIGS. 4 and 5. FIGS. 4 and 5 respectively illustrate exploded view and cross-sectional view of a central noise reduction loudspeaker assembled with an ear housing according to one embodiment. As shown in FIGS. 4 and 5, the central noise reduction loudspeaker 1 can be disposed within an ear housing 200 to form a noise reduction earphone. The central noise reduction loudspeaker 1 is disposed in the center of the ear housing 200 and the central through hole 111 aligns to the ear canal of the wearer so that the microphone 30 can receive the noise from the ear canal of the wearer.

Furthermore, since the microphone 30 is disposed on the central fixed frame 215 and located in the central through hole 111. In practice, the microphone 30 is disposed in the speaker unit 10, there is no need to set up any seat for engaging the microphone 30 in the front cavity 250 between the speaker unit 10 and the earphone housing 200.

In the present disclosure, one of the features of the central noise reduction loudspeaker 1 is that the diaphragm 11 comprising the central through hole 111. With the central through hole 111, the diaphragm 11 is capable of vibrating in a larger amplitude and higher frequency. Therefore, the audio signal can be performed closer to the original audio signal with less distortion. In addition, the microphone 30 receives the ambient noise, and an inverter disposed on the inverting circuit emits a sound wave in phase-reversed form to cancel the ambient noise through destructive interference so as to increase the signal-to-noise ratio (SNR) and increase the audio resolution. Furthermore, since the microphone 30 is disposed in central through hole 111, compared to conventional, the front cavity 250 and the overall size of the loudspeaker or earphone can be reduced and the production process can be simplified.

While the instant disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A central noise reduction loudspeaker, comprising:
a speaker unit comprising a diaphragm, the diaphragm comprising a central through hole located at center of the diaphragm;
a seat body, wherein the speaker unit is disposed within the seat body;
a top cap covering the seat body, the speaker unit being disposed between the top cap and the seat body, wherein the top cap comprises a central fixed frame penetrating the central through hole of the diaphragm; and
a microphone disposed within the central fixed frame and located in the central through hole.

2. The central noise reduction loudspeaker of claim 1, wherein the seat body comprises an outer ring seat, the top cap comprises an outer ring frame, and the outer ring frame is correspondingly assembled with the outer ring seat.

3. The central noise reduction loudspeaker of claim 2, wherein an outer periphery of the diaphragm is clamped between the outer ring frame and the outer ring seat.

4. The central noise reduction loudspeaker of claim 1, wherein the seat body comprises an inner ring seat, the top cap comprises an inner ring frame, and the inner ring frame is correspondingly assembled with the inner ring seat.

5. The central noise reduction loudspeaker of claim 4, wherein an inner periphery of the diaphragm is clamped between the inner ring frame and the inner ring seat.

6. The central noise reduction loudspeaker of claim 1, wherein the speaker unit comprises an upper yoke, a magnet, and a lower yoke, the magnet is disposed between the upper yoke and the lower yoke, the lower yoke is disposed on the seat body and comprises a flange to fix the magnet, the diaphragm is further connected to a voice coil, and the voice coil is located within a gap between the flange and the magnet.

7. The central noise reduction loudspeaker of claim 1, wherein the speaker unit and the microphone are electrically connected with a circuit board, and the circuit board is disposed on the bottom of the seat body.

8. A central noise reduction loudspeaker, comprising:
a speaker unit comprising a diaphragm, the central of the diaphragm comprising a central through hole;
a support seat supporting the speaker unit and comprising a central fixed frame, the central fixed frame penetrating the central through hole of the diaphragm;
a microphone disposed within the central fixed frame and located in the central through hole.

9. The central noise reduction loudspeaker of claim 8, wherein the seat body comprises a seat body and a top cap, the central fixed frame is disposed on the seat body.

10. The central noise reduction loudspeaker of claim 8, wherein the seat body comprises a seat body and a top cap, the central fixed frame is disposed on the top cap.
